(19) United States
(12) Patent Application Publication
(10) Pub. No.: US 2012/0057229 A1
(43) Pub. Date: Mar. 8, 2012

(54) DISPLAY APPARATUS

(76) Inventors: Ryo Kikuchi, Osaka (JP); Hiroshi Fukushima, Osaka (JP); Tomoo Takatani, Osaka (JP)

(21) Appl. No.: 13/263,175

(22) PCT Filed: Dec. 22, 2009
(86) PCT No.: PCT/JP2009/071295

§ 371 Date: Oct. 6, 2011

(30) Foreign Application Priority Data
Apr. 21, 2009 (JP) 2009-102851

(51) Int. Cl. G02B 27/22

(52) U.S. Cl. 359/463

(57) ABSTRACT

Provided is a display apparatus that can operate both in a portrait mode and a landscape mode, and that exhibits high front brightness and excellent resolution in both planar image display (2D display) and stereoscopic image display (3D display). The display apparatus of the present invention is a display apparatus provided with a display panel including a plurality of pixel areas, a parallax barrier disposed on one side of the display panel, and a lenticular lens disposed on the other side of the display panel. The parallax barrier is provided with a light-blocking sections and a light-transmitting section along a row direction or a column direction of the pixel areas. The lenticular lens includes a plurality of cylindrical lenses arrayed in the row direction or the column direction of the pixel areas. The array direction of the light-blocking sections and the light-transmitting sections is perpendicular to the array direction of the cylindrical lenses.

### TECHNICAL FIELD

The present invention relates to a display apparatus. More specifically, the present invention relates to a display apparatus in which images can be displayed stereoscopically.

### BACKGROUND ART

Ongoing developments have being made in recent years on display apparatuses that allow switching between planar image display (2D display) and stereoscopic image display (3D display) in one display screen, in display apparatuses that are used in mobile phones, game devices and the like.

Herein, 3D display should desirably be perceived by the naked eye without resorting to any special glasses or devices. The main known schemes for 3D display under the naked eye include binocular schemes that rely on video images, from two view-points, namely a left eye image and a right eye image, and multi-view schemes that rely on video images of three or more view-points.

In binocular display apparatuses, it is necessary to send dissimilar image information of the left and right eyes simultaneously in order to perform 3D display under the naked eye. Accordingly, methods are ordinarily used (for instance, Patent document 1) wherein images are separated by providing a lenticular lens (lenticular sheet) on a liquid crystal panel. Patent document 1 discloses a method for performing 3D display wherein two lenticular sheets are arranged in such a manner that the array direction of cylindrical lenses that make up each lenticular sheet are offset by 90° with respect to each other, such that 3D display is achieved by matching the focal planes of the lenticular sheets.

Parallax barrier schemes have also been proposed for performing 3D display in a binocular display apparatus (for instance, Patent document 2). In parallax barrier schemes, 3D display is performed using a barrier panel, called a parallax barrier, in which band-like light-transmitting sections and light-blocking sections are alternately disposed. Specifically, a parallax barrier is disposed in such a manner that a light source of a backlight of a liquid crystal panel traverses the parallax barrier, and a specific viewing angle is imparted, by the parallax barrier, to a right eye image and a left eye image that are generated in the liquid crystal panel. Thereby, the observer sees only images corresponding to the respective eyes, and perceives a 3D image as a result.

In parallax barrier schemes, display apparatuses such as cell phones or the like having multi-view directionality have been proposed (for instance, Patent document 3) that enable display of a display screen in a portrait mode (vertical screen display) or a landscape mode (horizontal screen display), and that allow the user to view an image without view-point modification.

### PRIOR ART REFERENCES

### [Patent Documents]

Patent document 1: JP 7-306484 A

Patent document 2: JP 2007-72269 A

Patent document 3: JP 2006-18282 A

In the method disclosed in Patent document 1, however, the travel direction of the light that traverses the liquid crystal panel is controlled by a lenticular lens. Therefore, although high brightness is achieved without blocking of light, the observer sees an image that has passed through two lenses, and hence resolution is impaired both in 3D display and 2D display. The above tendency is particularly pronounced in 2D display, where display quality is thus poor.

Upon separation of right eye images from left eye images during 3D display in binocular display apparatuses that utilize parallax barriers, images are separated by light-blocking sections provided in the parallax barrier, as disclosed in Patent documents 2 and 3. Therefore, the proportion of light-transmitting sections decreases necessarily, with an accompanying drop in front brightness. Also, the number of effective pixels in the left-right direction is halved during 3D display, so that the resolution is then half the resolution during 2D display.

Multi-view directionality display apparatuses require a parallax barrier for a portrait mode and for a landscape mode.

### DISCLOSURE OF THE INVENTION

In the light of the above, it is an object of the present invention to provide a display apparatus that can operate both in a portrait mode and a landscape mode, and that exhibits high front brightness and excellent resolution in both 2D and 3D display.

As a result of various studies on display apparatuses that enable good 3D display, the inventors came to focus on the characteristics of lenticular lenses and parallax barriers, and found that images having high brightness of good resolution can be obtained by exploiting high brightness, which is characteristic of lenticular lenses, and by using a combination with a parallax barrier that compensates for low resolution. The inventors found also that a high-brightness display apparatus having excellent resolution can be realized that accommodates both a portrait mode and a landscape mode, both in 2D display and 3D display, by using a lenticular lens and a parallax barrier for 2D display and 3D display, or for a portrait mode and a landscape mode, as the case may require. The inventors found that the above problems could be admirably solved thereby, and arrived thus at the present invention.

Specifically, the present invention is a display apparatus provided with a display panel including a plurality of pixel areas, a parallax barrier disposed on one side of the display panel, and a lenticular lens disposed on the other side of the display panel; wherein the parallax barrier is provided with a light-blocking section and a light-transmitting section along a row direction or a column direction of the pixel areas; the lenticular lens includes a plurality of cylindrical lenses arrayed in the row direction or the column direction of the pixel areas; and an array direction of the light-blocking section and the light-transmitting section is perpendicular to the array direction of the cylindrical lenses.

As the above display panel there can be used various types of display panel, for instance a liquid crystal panel, an organic EL panel or the like. If the display apparatus is a binocular display apparatus, however, the display panel is preferably a liquid crystal panel, since in that case the pixel areas of the display panel can be arrayed by being easily separated into right eye pixel areas and left eye pixel areas. Examples of liquid crystal panels in which right eye pixel areas and left eye pixel areas are arrayed separately from each other include, for instance, liquid crystal panels in which pixel areas are disposed in the form of a matrix, such that first columns in which a plurality of right eye pixel areas is disposed are alternately arranged with second columns in which a plurality of left eye pixel areas is disposed.

The parallax barrier partially blocks light that passes through the liquid crystal panel, and has a configuration wherein band-like light-transmitting sections and light-blocking sections are disposed equidistantly. The light-blocking sections are formed along the array direction of the right eye pixel areas and the left eye pixel areas, and can appropriately switch, as the case may require, between a light-blocking state in which voltage is applied (on state), and a light-transmitting state in which voltage is not applied (off state). During 3D display, for instance, 3D display can be performed by separating respectively dissimilar right eye images from left eye images, by setting a light-blocking state as the on state. Also, 2D display can be performed by setting a light-transmitting state as the off state.

Switching between the above-described on state and off state can be easily performed by using a parallax barrier made up of a liquid crystal panel. Using such a parallax barrier allows easily switching between 2D display and 3D display.

The lenticular lens is a compound lens including a plurality of cylindrical lenses arrayed in the row direction or the column direction of the pixel areas. When performing 3D display using a lenticular lens, the arrangement of the cylindrical lenses and of the pixel areas is adjusted in such a manner that the respectively dissimilar right eye images and left eye images are separated when passing through the lenticular lens.

Image display using the above lenticular lens boasts high brightness but is less amenable for switching between 2D display and 3D display than the abovementioned parallax barrier.

The parallax barrier and the lenticular lens are disposed in such a manner that the array directions of the light-blocking sections and the light-transmitting sections of the parallax barrier are perpendicular to the array direction of the cylindrical lenses that make up the lenticular lens.

In the present invention, good 3D display and 2D display can both be performed, with easy switching therebetween, by appropriately switching, as the case may require, between the parallax barrier and the lenticular lens disposed in the above-described manner. The display apparatus of the present invention, moreover, has multi-view directionality that enables a user to view an image without modification of the view-point, both in a portrait mode and a landscape mode.

The configuration of the display apparatus of the present invention is not especially limited by other components as long as it essentially includes such components.

In a preferred embodiment of the present invention, the lenticular lens is disposed furthest on an observation side; and the parallax barrier is disposed on a display surface side or rear face side of the display panel. In a display apparatus having such a configuration, front brightness is increased during 2D display, both in 2D display and in 3D display, thanks to the focusing effect of the lenticular lens disposed on the observation side of the display panel.

In a case where in such a configuration, for instance, the cylindrical lenses are arrayed in a row direction and the parallax barrier has formed therein a light-blocking section and a light-transmitting section along a column direction of the pixel areas, images can be separated by the parallax barrier when a portrait mode is performed, while images can be separated by the lenticular lens, in a state (off state) where no voltage is applied to the light-blocking section of the parallax barrier, when a landscape mode is performed. Therefore, good 3D display can be performed both in a portrait mode and a landscape mode.

The above aspects can be suitably combined with each other without departing from the scope of the present invention.

### EFFECT OF THE INVENTION

The present invention provides a display apparatus that can operate in both a portrait mode and a landscape mode, and that exhibits high front brightness and excellent resolution in both 2D and 3D display.

### BRIEF DESCRIPTION OF THE DRAWINGS

FIGS. 1 (a) to (c) illustrate the configuration of a display apparatus according to Embodiment 1, wherein FIG. 1(a) is a cross-sectional schematic diagram illustrating the configuration of a display apparatus, FIG. 1(b) is a plan-view schematic diagram illustrating the structure of a lenticular lens, and FIG. 1(c) is a plan-view schematic diagram illustrating the configuration of a parallax barrier panel;

FIGS. 2(a), (b) are plan-view schematic diagrams illustrating the configuration of a display apparatus at a time where 3D display is performed in the landscape mode, and FIGS. 2(c), (d) are plan-view schematic diagrams illustrating the configuration of the display apparatus at a time where 2D display is performed in the landscape mode;

FIGS. 3(a),(b) are plan-view schematic diagrams illustrating the configuration of a display apparatus at a time where 3D display is performed, and FIGS. 3(c), (d) at a time where 2D display is performed, in a portrait mode; and

FIG. 4 is a cross-sectional schematic diagram illustrating the configuration of another example of a display apparatus according to Embodiment 1.

### MODES FOR CARRYING OUT THE INVENTION

The present invention is explained in more detail below based on embodiments. However, the present invention is not limited to these embodiments alone.

### Embodiment 1

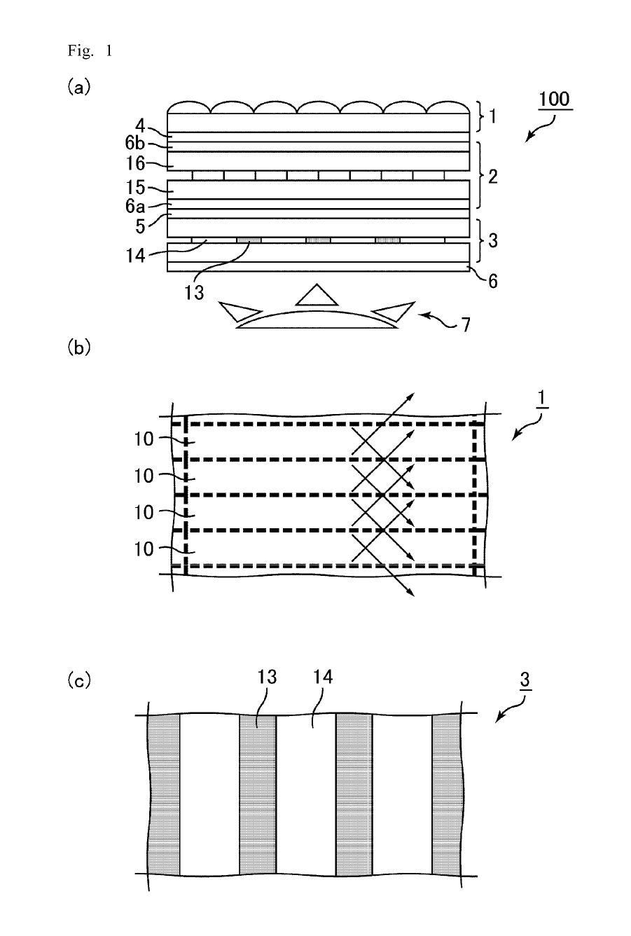

FIGS. 1 (a) to (c) illustrate the configuration of a display apparatus according to the present embodiment, wherein FIG. 1(a) is a cross-sectional schematic diagram illustrating the configuration of the display apparatus, FIG. 1(b) is a plan-view schematic diagram illustrating the structure of a lenticular lens, and FIG. 1(c) is a plan-view schematic diagram illustrating the configuration of a parallax barrier panel.

In FIG. 1(a), a display apparatus 100 comprises a lenticular lens 1, a liquid crystal panel 2 and a parallax barrier panel 3, in this order. The lenticular lens 1 is affixed to the display surface side of the liquid crystal panel 2 via the adhesive layer 4. The parallax barrier panel 3 is affixed to the rear face side of the liquid crystal panel 2 via an adhesive layer 5. A polarizer 6 and a light source 7 are disposed on the rear face side of the parallax barrier panel 3.

The liquid crystal panel 2 has a structure wherein a TFT array substrate 15 and a color filter substrate (CF substrate) 16 are disposed opposing each other across an interposed sealing material (not shown), such that a liquid crystal is sandwiched between the two substrates. Polarizers 6a, 6b are provided on respective main surfaces, of the TFT array substrate 15 and the CF substrate 16, on the reverse of the side of the liquid crystal layer.

As illustrated in FIG. 1(b), in the lenticular lens 1, a plurality of cylindrical lenses 10 is disposed along a direction that intersects the row direction of pixel areas, such that barrier shapes for separating images are disposed as horizontal stripes.

The parallax barrier panel 3 is a panel in which a liquid crystal is sandwiched between a pair of substrates, and in which the light-blocking sections 13 can be switched between a light-blocking state and a light-transmitting state by adjusting voltage applied to a liquid crystal. The band-like light-blocking sections 13 and light-transmitting sections 14 are disposed alternately, as illustrated in FIG. 1(c), such that barrier shapes for separating images are disposed as vertical stripes.

The lenticular lens 1 and the parallax barrier panel 3 are disposed in such a manner that the respective barrier shapes are perpendicular to each other.

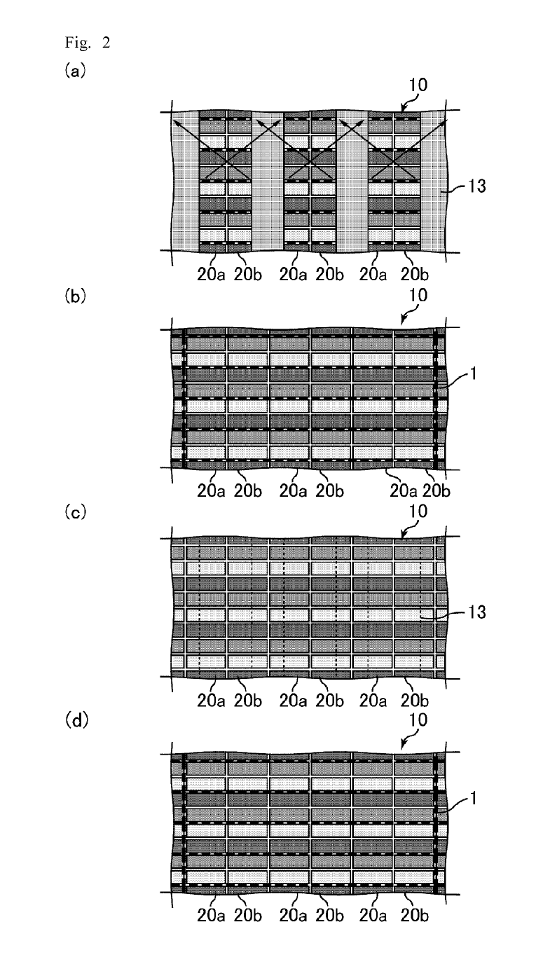

The display apparatus 100 configured as described above can switch between 3D display and 2D display, as the case may require. FIGS. 2(a), (b) are plan-view schematic diagrams illustrating the configuration of a display apparatus 100 at a time where 3D display is performed in the landscape mode, and FIGS. 2(c), (d) are plan-view schematic diagrams illustrating the configuration of the display apparatus 100 at a time where 2D display is performed in the landscape mode.

In FIGS. 2(a) to (d), a plurality of rectangular pixel areas comprising each three colors R (red), G (green) and B (blue) is formed in the liquid crystal panel 10, such that columns in which a plurality of left eye pixel areas 20a is disposed are alternately arranged with columns in which a plurality of right eye pixel areas 20b is disposed. FIGS. 2(a), (c) illustrate the display apparatus 100 when viewed from a rear face side, and FIGS. 2(b), (d) illustrate the display apparatus 100 when viewed from the observation side.

In 3D display in a landscape mode, voltage is applied to the light-blocking sections 13, arrayed along columns, of the pixel areas 20a, 20b, as illustrated in FIG. 2(a). Thereby, a left eye image and a right eye image are separated, and dissimilar image information is sent simultaneously to the left and right eyes. As a result, 3D display under the naked eye is enabled, although some resolution is lost as compared with 2D display.

The lenticular lens 1 is an array of horizontal stripes, as illustrated in FIG. 2(b). Therefore, the lenticular lens 1 does not affect the above-described left-right image separation. Also, the lenticular lens 1 is disposed furthest on the observation side in the display apparatus 100. This enables good light focusing, and allows realizing high-brightness image display.

Upon 2D display in the landscape mode, as illustrated in FIG. 2(c), there is a state (off state) in which no voltage is applied to the parallax barrier panel 3, and the light-blocking sections 13 do not operate. Good 2D display can be performed as a result without incurring loss of resolution.

The lenticular lens 1 is an array of horizontal stripes, as illustrated in FIG. 2(d). Therefore, in the same way as described above, a high focusing effect is elicited, without influencing left-right image separation. High-brightness image display can be afforded as a result.

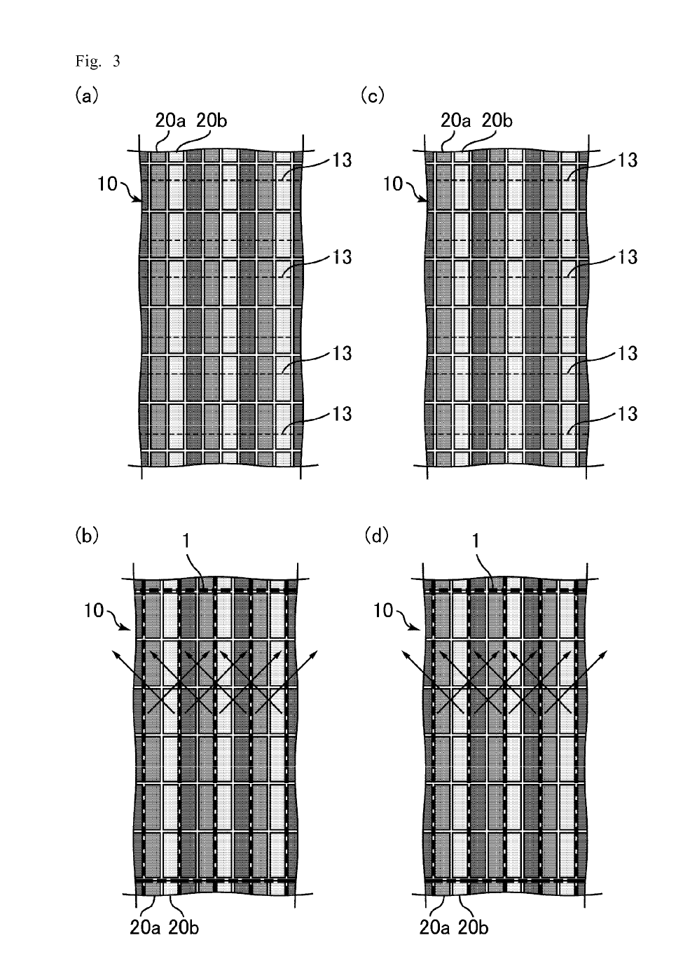

FIGS. 3(a), (b) are plan-view schematic diagrams illustrating the configuration of the display apparatus 100 at a time where 3D display is performed in the portrait mode, and FIGS. 3(c), (d) are plan-view schematic diagrams illustrating the configuration of the display apparatus 100 at a time where 2D display is performed in the portrait mode.

In FIGS. 3(a) to (d), the display panel of the liquid crystal panel 10 has a portrait orientation, and hence, unlike in the landscape mode, a plurality of rectangular pixel areas is arrayed in the vertical direction, The parallax barrier panel 3 is disposed as horizontal stripes, and the lenticular lens 1 is disposed as vertical stripes. FIGS. 3(a), (c) illustrate the display apparatus 100, viewed from a rear face side, and FIGS. 3(b), (d) illustrate the display apparatus 100 when viewed from the observation side.

Upon 3D display in the portrait mode, as illustrated in FIG. 3(a), no voltage is applied to the parallax barrier panel 3, and the image is not separated into left and right. The lenticular lens 1 is an array of vertical stripes, as illustrated in FIG. 3(b). Therefore, the image is separated into left and right. As a result, good 3D display can be performed without incurring loss of resolution.

Upon 2D display in the portrait mode, as illustrated in FIG. 3(c), there is a state (off state) in which no voltage is applied to the parallax barrier panel 3, and the light-blocking sections 13 do not operate. The lenticular lens 1 is an array of vertical stripes, as illustrated in FIG. 3(b). Therefore, the image is separated into left and right. In 2D display, however, the left eye image and the right eye image are the same image, and hence there is no loss of resolution.

In both 3D display and 2D display, a high focusing effect can be obtained as a result of the focusing effect of the lenticular lens 1 disposed on the display surface side.

Therefore, although in the display apparatus 100 according to the present embodiment there is some loss of resolution during 3D display in the landscape mode, no resolution is lost in the portrait mode, and high front brightness is achieved in both display modes. Display characteristics in 2D display are excellent in that there is no resolution loss in either display mode, and in that excellent front brightness is achieved.

The purpose of the configuration of the above-described embodiment is enabling good image display during 3D display in a portrait mode. However, the present invention is not limited to such an embodiment, and desired image characteristics can be obtained by modifying the array direction of the lenticular lens 1 and of the parallax barrier panel 3 in accordance with the application in which the invention is used.

In a case where good image display is to be achieved during 3D display in the landscape mode, for instance the barrier shapes of the lenticular lens 1 are disposed as vertical stripes, and the barrier shapes of the parallax barrier panel 3 are disposed as horizontal stripes. In the portrait mode, the barrier shapes of the lenticular lens 1 are disposed as horizontal stripes, and the barrier shapes of the parallax barrier panel 3 are disposed as vertical stripes. As a result, although some resolution is lost during 3D display in the portrait mode, there is no loss of resolution during in the landscape mode, and high front brightness is achieved in both display modes. During 2D display, no resolution is lost in either display mode, and there can be realized good image display with high front brightness.

### Comparative Embodiment 1

For purposes of comparison with the above-described embodiment 1, no lenticular lens was used, and the parallax barrier was provided only on the rear face side of the liquid crystal panel. The obtained display apparatus had sufficient front brightness during 2D display, but exhibited reduced front brightness during 3D display. The resolution during 3D display was about ½ that during 2D display.

### Comparative Embodiment 2

For purposes of comparison with the above-described embodiment 1, no parallax barrier was used, and the lenticular lens was provided only on the display surface side of the liquid crystal panel. The obtained display apparatus exhibited high front brightness both during 2D display and 3D display, but reduced resolution during 2D display.

The embodiment above has been explained based on an example in which each pixel area of the liquid crystal panel 2 comprises three colors R (red), G (green) and B (blue). However, the present invention is not limited thereto, and may comprise any of the above color filter layers, or other color filter layers.

In the embodiment above, the lenticular lens 1 is disposed furthest on the observation side of the display apparatus. However, the present invention is not limited thereto, and so long as the focusing effect of the lenticular lens 1 is not impaired thereby, a protective plate, chassis or the like for protecting the display apparatus may be provided on the focusing surface side of the lenticular lens 1.

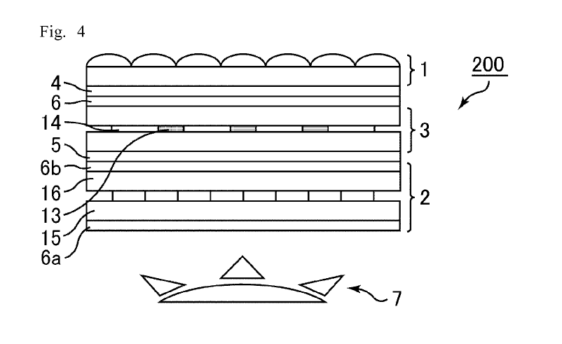

In the embodiment above, the parallax barrier 3 is provided on the rear face side of the liquid crystal panel 2, but the present invention is not limited thereto, and may have a configuration such as the one illustrated in FIG. 4. FIG. 4 is a cross-sectional schematic diagram illustrating the configuration of another example according to Embodiment 1. In a display apparatus 200 of FIG. 4, the parallax barrier 3 is provided on the display surface side of the liquid crystal panel 2. Such a configuration elicits the same effect as in the display apparatus 100 illustrated in FIG. 1(a).

A chassis or the like may be disposed on the rear face side of the parallax barrier 3 of the display apparatus 100 illustrated in FIG. 1(a). Similarly, a chassis or the like may be disposed on the rear face side of the liquid crystal panel 2 of the display apparatus 200 illustrated in FIG. 4.

The above embodiments can be suitably combined with each other without departing from the scope of the present invention.

The present application claims priority to Patent Application No. 2009-102851 filed in Japan on Apr. 21, 2009 under the Paris Convention and provisions of national law in a designated State, the entire contents of which are hereby incorporated by reference.

### EXPLANATION OF REFERENCE NUMERALS

1 lenticular lens

2 liquid crystal panel

3 parallax barrier panel

4, 5 adhesive layer

6, 6a, 6b polarizer

7 light source

10 cylindrical lens

13 light-blocking section

14 light-transmitting section

15 TFT array substrate

16 CF substrate

20a left eye pixel area

20b right eye pixel area

100, 200 display apparatus

1. A display apparatus comprising:
a display panel including a plurality of pixel areas,
a parallax barrier disposed on one side of the display panel, and
a lenticular lens disposed on the other side of the display panel,
wherein the parallax barrier is provided with a light-blocking section and a light-transmitting section along a row direction or a column direction of the pixel areas,
the lenticular lens includes a plurality of cylindrical lenses arrayed in the row direction or the column direction of the pixel areas, and
an array direction of the light-blocking section and the light-transmitting section is perpendicular to the array direction of the cylindrical lenses.

2. The display apparatus according to claim 1,
wherein the lenticular lens is disposed furthest on an observation side; and
the parallax barrier is disposed on a display surface side or rear face side of the display panel.
